(19) United States
(12) Patent Application Publication
(10) Pub. No.: US 2024/0405197 A1
(43) Pub. Date: Dec. 5, 2024

(54) PREPARATION METHOD FOR SILICON-CARBON COMPOSITE NEGATIVE ELECTRODE MATERIAL

(71) Applicant: Graphex Technologies LLC., Royal Oak, MI (US)

(72) Inventors: Xingtao LI, Hong Kong (CN); Bin QIU, Hong Kong (CN); Frank YU, Hong Kong (CN)

(21) Appl. No.: 18/326,662

(22) Filed: May 31, 2023

(51) Int. Cl. H01M 4/36; H01M 4/04; H01M 4/38; H01M 4/583

(52) U.S. Cl. CPC H01M 4/364; H01M 4/0471; H01M 4/386; H01M 4/583; H01M 2004/027

(57) ABSTRACT

The invention discloses a preparation method of silicon-carbon composite negative electrode material, relates to the field of negative electrode materials preparation The method includes the following steps: mixing starch with water, and carrying out stirring, dispersing, cooling and standing; soaking a mixture in an ethanol solution and absolute ethyl alcohol, collecting a white solid, performing supercritical drying, crushing, then mixing the solid with a carbon source, keeping the temperature at 180-300° C., 450-600° C., and then 1000-1200° C., carrying out cooling to room temperature, and mixing a carbonized material with a graphite negative electrode material. According to the invention, the elastic material is used to improve electric conduction and achieve lithium storage. When it is filled between the coating layer and the silicon material, good conductivity is kept, effects of silicon can be used, and the defects of silicon can be avoided at the same time.

### TECHNICAL FIELD

The invention relates to a preparation method for negative electrode material.

### BACKGROUND

Silicon is a very promising new generation of negative electrode materials due to its theoretical gram capacity as high as 4200 mAh/g. However, silicon is prone to volume expansion (>300%) during charge and discharge, causing silicon particles to be pulverized. In addition, the exposed silicon during charge and discharge continuously consumes the electrolyte to form a new SEI film, which causes the low cycle life and poor performance of lithium-ion batteries. As such, the wide application of silicon materials in lithium-ion batteries is seriously affected.

The surface modification of silicon materials restrains the volume expansion of silicon and achieves a certain inhibitory effect, but this also seriously prevents silicon from exerting its high gram capacity.

### SUMMARY

The purpose of the present invention is provided a preparation method for silicon-carbon composite negative electrode material in order to solve the problem as following: silicon is prone to volume expansion during the charge and discharge process, resulting in the pulverization of silicon particles, and the exposed silicon during the charge and discharge process continuously consumes the electrolyte to form a new SEI film, resulting in the low cycle life and poor use performance of the lithium-ion battery, and the surface modification of the silicon material inhibits silicon from exerting its high gram capacity.

A preparation method for silicon-carbon composite negative electrode material is described as follows.

Step 1: putting nano-silicon and water into a disperser according to the mass ratio of 1: (0.5-5) and disperse evenly to obtain a nano-silicon aqueous solution:

Step 2: mixing starch and water according to the mass ratio of 1: (0.1-10), and stir for 1-20 minutes at a temperature of 85-95° C., at the same time.

Step 3: putting the nano-silicon aqueous solution obtained by step 1 and the starch solution obtained in step 2 into the disperser, according to the mass ratio of nano-silicon and starch (0.5-5): (0.1-10) to disperse until uniform and form a gel solution.

Step 4: cooling the gel solution to room temperature and let it stand for 8-48 hours.

Step 5: Soaking the gel solution obtained by step 4 with ethanol solution until the gel solution turns into a white solid, and then using absolute ethanol to continue soaking for 1 to 24 hours, and collecting the white solid.

Step 6: putting the white solid into a supercritical dryer for drying, and crushing the dried white solid to D50=13-25 microns

Step 7: mixing a pulverized material obtained by step 6 with carbon source in a mass ratio of (2˜15): 1;

Step 8: heating the mixed material obtained by step 7 in a reactor to 180-400° C. at a rate of no more than 10° C. per minute, keeping the temperature constant for 1-3 hours, and continue to heat up to 450-600° C. at a rate of no more than 5° C. per minute, keeping the temperature constant for 1 to 3 hours, stirring at a speed of 100 to 200 rpm in the whole process, and at the same time passing through the protective gas to complete the carbon source coating, cooling to room temperature, and obtaining a coated material

Step 9. heating the coated material to 1000-1200° C. at a rate of no more than 6° C. per minute in a protective gas atmosphere, keeping the temperature constant for 1-5 hours, and cooling to room temperature to obtain a carbonized material;

Step 10: mixing the carbonized material with the graphite negative electrode material to generate a silicon-carbon composite negative electrode material.

The carbon source according to step 7 is pitch, resin or sucrose.

The protective gas according to step 8 is selected from one or more of nitrogen, helium, neon, argon, krypton, xenon and radon.

The protective gas according to step 9 is selected from one or more of nitrogen, helium, neon, argon, krypton, xenon and radon.

The graphite negative electrode material according to step 10 is an artificial graphite negative electrode material or a natural graphite negative electrode material

The carbonized material according to step 10 is mixed with the graphite negative electrode material in a mass ratio of 1: (1-99).

### DETAILED DESCRIPTION

The technical solution of the present invention is not limited to the specific embodiments listed below, but also includes any combination of the specific embodiments.

Embodiment 1: the preparation method for silicon-carbon composite negative electrode material is described as follows.

Step 1: putting nano-silicon and water into a disperser for evenly dispersing according to the mass ratio of 1: (0.5-5), in order to obtain a nano-silicon aqueous solution.

Step 2: mixing starch and water according to the mass ratio of 1: (0.1-10), and stirring it for 1-20 minutes at a temperature of 85-95° C., at the same time.

Step 3: putting the nano-silicon aqueous solution obtained by step 1 and the starch solution obtained in step 2 into the disperser for evenly dispersing, according to the mass ratio of nano-silicon and starch (0.5-5): (0.1-10), in order to form a gel solution.

Step 4: cooling the gel solution to room temperature and let it stand for 8-48 hours.

Step 5: Soaking the gel solution obtained by step 4 with ethanol solution until the gel solution turns into a white solid, and then collecting the white solid after soaking with absolute ethanol for 1 to 24 hours.

Step 6: putting the white solid into a supercritical dryer for drying, and crushing the dried white solid to D50=13-25 microns.

Step 7: mixing a pulverized material obtained by step 6 with carbon source in a mass ratio of (2˜15): 1.

Step 8: heating the mixed material obtained by step 7 in a reactor to 180-400° C. at a rate of no more than 10° C. per minute, and keeping the temperature constant for 1-3 hours; and then heating up to 450-600° C. at a rate of no more than 5° C. per minute, and keeping the temperature constant for 1 to 3 hours; during the whole heat process the mixed material is stirred at a speed of 100 to 200 rpm, and the protective gas is passed through; after the carbon source coating process completed, cooling it to room temperature, and obtaining a coated material.

Step 9. heating the coated material to 1000-1200° C. at a rate of no more than 6° C. per minute in a protective gas atmosphere, keeping the temperature constant for 1-5 hours, and cooling it to room temperature to obtain a carbonized material.

Step 10: mixing the carbonized material with the graphite negative electrode material to generate a silicon-carbon composite negative electrode material.

The present invention uses an elastic material, which can conduct electricity and has a certain lithium storage capacity, to be filled between the coating layer and the silicon material. When the silicon volume expands, the elastic material shrinks, and when the silicon volume shrinks, the elastic material restores to the original state, keep close contact with the silicon material at all times, and maintain good electrical conductivity, so that not only the role of silicon can be play, but also the shortcomings of silicon can be avoided.

The carbon gel material obtained after the starch gel solution is processed meets the above-mentioned characteristics, and when used in conjunction with the silicon material, it can give full play to the characteristics of the silicon-carbon composite negative electrode material.

Embodiment 2: the difference between embodiment 2 and embodiment 1 is that: the carbon source in step 7 is pitch, resin or sucrose. The others are the same as the embodiment 1.

Embodiment 3: the difference between embodiment 3 and embodiments 1-2 is that: the temperature is heated to 400° C. at a rate of no more than 10° C. per minute, in Step 8. The others are the same as the embodiments 1-2.

Embodiment 4: the difference between embodiment 4 and embodiments 1-3 is that: the temperature is continuously raised to 600° C. at a rate of no more than 5° C. per minute, in step 8. The others are the same as the embodiments 1-3.

Embodiment 5: the difference between embodiment 4 and embodiments 1-3 is that the protective gas in step 8 is selected from one or more of nitrogen, helium, neon, argon, krypton, xenon and radon. The others are the same as the embodiments 1-4.

Embodiment 6: the difference between embodiment 5 and embodiments 1-5 is that: the protective gas in step 9 is selected from one or more of nitrogen, helium, neon, argon, krypton, xenon and radon. The others are the same as the embodiments 1-5.

Embodiment 7: the difference between embodiment 7 and embodiments 1-6 is that: the temperature is heated to 1050-1150° C. at a rate of no more than 6° C. per minute, in step 9. The others are the same as the embodiments 1-6.

Embodiment 8: the difference between embodiment 8 and embodiments 1-7 is that: the temperature is heated to 1100° C. at a rate of no more than 6° C. per minute, in step 9. The others are the same as the embodiments 1-7.

Embodiment 9: the difference between embodiment 9 and embodiments 1-8 is that the graphite negative electrode material in step 10 is selected from artificial graphite negative electrode material or natural graphite negative electrode material. The others are the same as the embodiments 1-8.

Embodiment 10: the difference between embodiment 10 and embodiments 1-9 is that the carbonized material in step 10 is mixed with the graphite negative electrode material at a mass ratio of 1: (1-99). The others are the same as the embodiments 1-9.

The effect of the present invention can be verified by following experiments.

### Experiment 1

A preparation method for silicon-carbon composite negative electrode material is described as follows.

Step 1: putting nano-silicon and water into a disperser for evenly dispersing according to the mass ratio of 1:2.

Step 2: mixing starch and water according to the mass ratio of 1:1, and stirring

it for 10 minutes at a temperature of 95° C., at the same time.

Step 3: putting the starch solution obtained in step 2 into the disperser, and forming a gel solution after evenly dispersing.

Step 4: cooling the gel solution to room temperature and let it stand for 24 hours.

Step 5: Soaking the gel solution obtained by step 4 with ethanol solution until the gel solution turns into a white solid, and then soaking the white solid with absolute ethanol for 10 hours and collecting the white solid after soaking.

Step 6: putting the white solid into a supercritical dryer for drying, and crushing the dried white solid to D50=15 microns.

Step 7: mixing a pulverized material obtained by step 6 with carbon source in a mass ratio of 4:1.

Step 8: heating a mixed material obtained by step 7 in a reactor to 350° C. at a rate of 4° C. per minute, and keeping the temperature constant for 1 hour; and then heating up to 600° C. at a rate of 2° C. per minute, and keeping the temperature constant for 2 hours; during the whole heat process the mixed material is stirred at a speed of 150 rpm, and the protective gas is passed through; after the carbon source coating process completed, cooling it to room temperature and obtaining a coated material.

Step 9. heating the coated material to 1100° C. at a rate of 4° C. per minute in a protective gas atmosphere, keeping the temperature constant for 2 hours, and cooling it to room temperature to obtain a carbonized material.

Step 10: mixing the carbonized material with the graphite negative electrode material at a mass rate of 1:7 to generate a silicon-carbon composite negative electrode material.

The carbonized material obtained by step 9 is a mixture of nano-silicon and amorphous carbon, the theoretical calculation value of the mass ratio is about 11:9, and the measured material gram capacity is 2357.4 mAh/g, which is close to the theoretical calculation value.

The silicon-carbon composite negative electrode material obtained by step 10 has a gram capacity of 595.3 mAh/g, which can meet the performance of current negative electrode materials, and control the cost more reasonable than the material obtained by step 9.

### Experiment 2

A preparation method for silicon-carbon composite negative electrode material is described as follows.

Step 1: putting nano-silicon and water into a disperser for evenly dispersing according to the mass ratio of 1:1.5.

Step 2: mixing starch and water according to the mass ratio of 1:1.5, and stirring it for 10 minutes at a temperature of 95° C., at the same time.

Step 3: putting the starch solution obtained in step 2 into the disperser, and forming a gel solution after evenly dispersing.

Step 4: cooling the gel solution to room temperature and let it stand for 24 hours.

Step 5: Soaking the gel solution obtained by step 4 with ethanol solution until the gel solution turns into a white solid, and then soaking the white solid with absolute ethanol for 10 hours and collecting the white solid after soaking.

Step 6: putting the white solid into a supercritical dryer for drying, and crushing the dried white solid to D50=17 microns.

Step 7: mixing a pulverized material obtained by step 6 with carbon source in a mass ratio of 7:3.

Step 8: heating a mixed material obtained by step 7 in a reactor to 350° C. at a rate of 4° C. per minute, and keeping the temperature constant for 1 hour; and then heating up to 600° C. at a rate of 2° C. per minute, and keeping the temperature constant for 2 hours; during the whole heat process the mixed material is stirred at a speed of 150 rpm, and the protective gas is passed through; after the carbon source coating process completed, cooling it to room temperature and obtaining a coated material. Step 9. heating the coated material to 1100° C. at a rate of 4° C. per minute in a protective gas atmosphere, keeping the temperature constant for 2 hours, and cooling it to room temperature to obtain a carbonized material.

Step 10: mixing the carbonized material with the artificial graphite negative electrode material at a mass rate of 1:7 to generate a silicon-carbon composite negative electrode material.

The gram capacity of the carbonized material obtained by step 9 is 2068.0 mAh/g, the gram capacity decreases with the increase of carbon source content, but the structure stability is higher and the rate performance is better.

The gram capacity of the composite negative electrode material obtained by step 10 is 561.9 mAh/g.

What is claimed is:

1. A preparing method for silicon-carbon composite negative electrode material, comprising:
step1: putting a nano-silicon and water into the disperser, according to a mass ratio of 1: (0.5-5) and dispersing evenly to obtain the nano-silicon aqueous solution;
step 2: mixing starch and water according to the mass ratio of 1: (0.1-10), and stirring for 1-20 minutes at a temperature of 85-95° C.; at the same time;
step 3: adding the nano-silicon aqueous solution and a starch solution obtained by step 2 into the disperser according to the mass ratio of nano-silicon and starch (0.5-5): (0.1-10), and dispersing evenly to form a gel solution;
step 4: cooling the gel solution to room temperature and standing for 8-48 hours;
step 5: soaking the gel solution with ethanol solution until a gel turning into a white solid, and then using absolute ethanol to soaking the white solid for 1 to 24 hours, and collecting the white solid;
step 6: putting the white solid into a supercritical dryer for drying, and crushing the dried white solid to D50=13-25 microns;
step 7: uniformly mixing a pulverized material obtained by step 6 with the carbon source according to a mass ratio of (2˜15): 1;
step 8: heating a mixed material obtained by step 7 in a reactor to 180-400° C. at a rate of no more than 10° C. per minute, keeping temperature constant for 1-3 hours, and continue to heat up to 450-600° C. at a rate of no more than 5° C. per minute, keep temperature constant for 1 to 3 hours, stirring at a speed of 100 to 200 rpm in the whole process, and at the same time passing through the protective gas to complete the carbon source coating, cooling to room temperature, and obtaining a coated material;
step 9: heating the coated material to 1000-1200°° C. at a rate of no more than 6° C. per minute in a protective gas atmosphere, keeping temperature constant for 1-5 hours, and cooling to room temperature to obtain a carbonized material;
step 10: mixing the carbonized material with a graphite negative electrode material to obtain a silicon-carbon composite negative electrode material.

2. The preparing method for silicon-carbon composite negative electrode material according to claim 1, wherein the carbon source of step 7 is selected of pitch, resin or sucrose.

3. The preparing method for silicon-carbon composite negative electrode material according to claim 1, wherein the mixed material obtained by step 7 is heated to 400° C. at a rate of no more than 10° C. per minute, in step 8.

4. The preparing method for silicon-carbon composite negative electrode material according to claim 1, wherein the mixed material is continued to heat up to 600° C. at a rate of no more than 5° C. per minute, in step 8.

5. The preparing method for silicon-carbon composite negative electrode material according to claim 1, wherein the protective gas used in step 8 is selected one or more of nitrogen, helium, neon, argon, krypton, xenon and radon.

6. The preparing method for silicon-carbon composite negative electrode material according to claim 1, wherein the protective gas used in step 9 is selected one or more of nitrogen, helium, neon, argon, krypton, xenon and radon.

7. The preparing method for silicon-carbon composite negative electrode material according to claim 1, wherein the coated material is heated to 1050-1150° C. at a rate of no more than 6° C. per minute, in step 9.

8. The preparing method for silicon-carbon composite negative electrode material according to claim 1, wherein the coated material is heated to 1100° C. at a rate of no more than 6° C. per minute, in step 9.

9. The preparing method for silicon-carbon composite negative electrode material according to claim 1, wherein the graphite negative electrode material in step 10 is an artificial graphite negative electrode material or a natural graphite negative electrode material.

10. The preparing method for silicon-carbon composite negative electrode material according to claim 1, wherein the carbonized material is mixed with the graphite negative electrode material according to a mass ratio of 1: (1-99), in step 10.
